(19) United States
(12) Patent Application Publication
(10) Pub. No.: US 2014/0310187 A1
(43) Pub. Date: Oct. 16, 2014

(54) BROKER-GENERATED PROSPECTIVE TENANT DATABASE FOR REAL ESTATE TRANSACTIONS

(71) Applicants: Alexander Solomon Baumol, New York, NY (US); Sufyan Nouri Sigg, Brooklyn, NY (US)

(72) Inventors: Alexander Solomon Baumol, New York, NY (US); Sufyan Nouri Sigg, Brooklyn, NY (US)

(21) Appl. No.: 13/859,921

(22) Filed: Apr. 10, 2013

(51) Int. Cl. G06Q 50/16; G06Q 30/06

(52) U.S. Cl. CPC G06Q 50/163; G06Q 30/0645
USPC 705/307

(57) ABSTRACT

A web application to match prospective tenants and commercial real estate spaces by creating a broker-generated searchable prospective tenant database which affords users the ability to create a plurality of prospective tenant listings on a single account. Additionally, a web application to receive prospective tenant information to create useful prospective tenant listings that make up this searchable prospective tenant database. Additionally, a web application to display prospective tenant listings that intersect with search attributes and search geographic areas. Additionally, a web application to display prospective tenant listings associated with a broker's account accessible on that broker's broker profile page.

### DRAWINGS-FIGURES

FIG. 1 is a flow chart demonstrating the process through which prospective tenant listings get created in a prospective tenant-generated system and the desirability of each potential outcome.

FIG. 2 is a flow chart demonstrating the process through which prospective tenant listings get created in a broker-generated system and the desirability of each potential outcome.

FIG. 3 is a flow chart demonstrating which segments of the prospective tenant market an employee-generated system will source for prospective tenant listings and the quality of information on these prospective tenant listings.

FIG. 4 is a flow chart demonstrating which segments of the prospective tenant market a broker-generated system will source for prospective tenant listings and the quality of information on these prospective tenant listings.

FIG. 5 demonstrates why using a radius to represent a prospective tenant's prospective tenant geographic area is not optimal.

FIG. 6 demonstrates why using a polygon to represent a prospective tenant's prospective tenant geographic area is advantageous.

FIG. 7 is a diagram demonstrating types of intersections between search attributes and prospective tenant attributes, both in the form of ranges.

FIG. 8 is a diagram demonstrating types of intersections between search geographic areas and prospective tenant geographic areas.

FIG. 9 is a flow chart that demonstrates how in a large market with many prospective tenants using multiple search attributes and search geographic areas can help a broker cut the prospective tenant pool into a manageable number.

FIG. 10 is a flow chart showing the steps a broker takes to use a possible embodiment of the invention.

FIG. 11 is a possible embodiment of the invention showing how a prospective tenant's prospective tenant attributes and prospective tenant geographic area can be received by the web application in order to create a prospective tenant listing.

FIG. 12 is a possible embodiment of the invention showing how search attributes and search geographic area can be received by the web application, which then displays the appropriate prospective tenant listings.

FIG. 13 is a possible embodiment of the invention showing how the web application can receive search geographic area or prospective tenant geographic area.

FIG. 14 is a possible embodiment of the invention showing how the web application can display a prospective tenant listing.

FIG. 15 is a possible embodiment of the invention showing how the web application can display a broker profile page.

### DETAILED DESCRIPTION

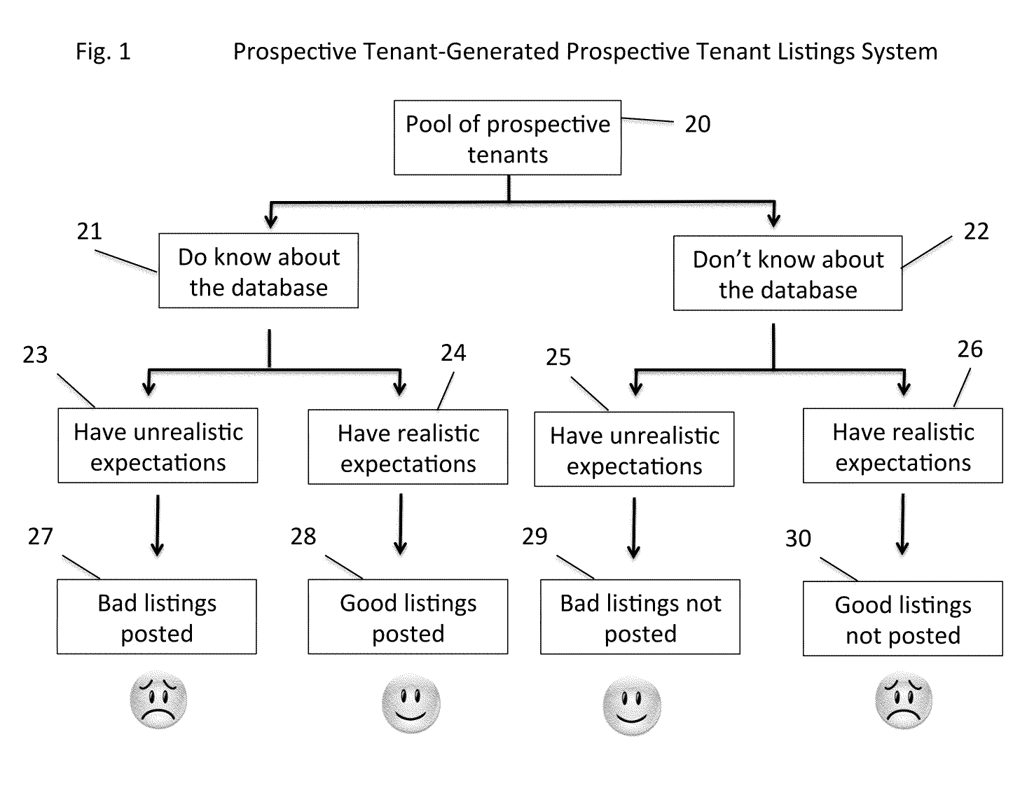

FIG. 1 is a flow chart demonstrating the process through which prospective tenant listings get created in a prospective tenant-generated system and the desirability of each potential outcome. In the commercial real estate market there exists at all times a pool of prospective tenants 20. This diagram tracks which prospective tenants will eventually make it onto a prospective tenant-generated prospective tenant database. Because prospective tenants are not real estate professionals, there is a significant risk that they will be unaware of this prospective tenant database 22 and will therefore never post themselves as a prospective tenant listing. In the instance of unrealistic prospective tenants 23/25 it is beneficial when they don't post themselves 29, but in the case of realistic prospective tenants 24/26 it is detrimental when they don't post themselves 30 as it reduces the number of quality prospective tenant listings in the database. Missing these quality prospective tenant listings reduces the database's value.

An example of a prospective tenant with unrealistic expectations 23/25 is somebody who is unqualified financially to rent space that they seek. A significant proportion of prospective tenants have these unrealistic expectations. Any unrealistic prospective tenants 23/25 that know about the database will post themselves 27 as they believe their goals are viable. Unrealistic prospective tenant listings dilute the database and make it much less effective to search through when looking for prospective tenants to take a space.

The realistic prospective tenants who know about the database 24 will post themselves as well 28. These are the quality prospective tenant listings on the database. Quality prospective tenant listings will co-mingle with the prospective tenant listings that have no chance of resulting in a lease transaction. The higher proportion of realistic prospective tenant listings to unrealistic prospective tenant listings, the more efficient the database.

As is demonstrated by the diagram, a prospective tenant-generated prospective tenant listings system results in some bad prospective tenant listings being posted 27 and some good prospective tenant listings being missed altogether 30. Because of this, the quality prospective tenant listings in the database are not sufficient to make the database valuable and efficient on their own.

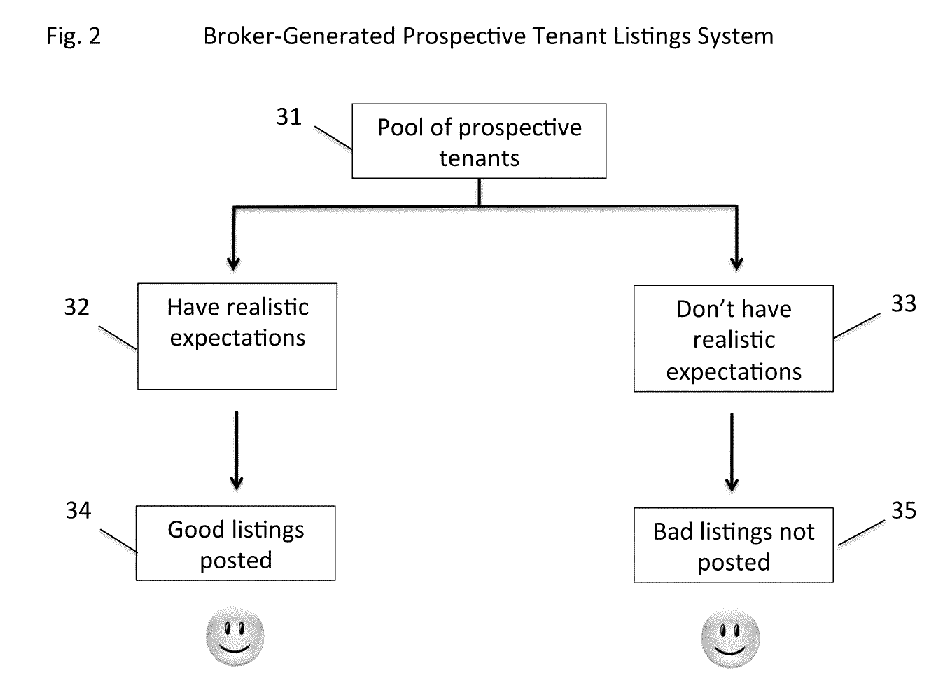

FIG. 2 is a flow chart demonstrating the process through which prospective tenant listings 31 get created in a broker-generated system and the desirability of each potential outcome.

A broker-generated database is one that has a system in place to receive from brokers information about prospective tenants. This information can be received through means that include but are not limited to phone, email, online form, text message, and/or fax.

In FIG. 1 we posited that a significant portion of prospective tenants would not have heard of the database 22 because they are not real estate professionals. In the case of a broker-generated prospective tenant listings system we do not need to segment the prospective tenants by this criteria because brokers as real estate professionals, will be aware of any major prospective tenant database as it would be essential to their jobs.

Furthermore, brokers, because of their experience, will be able to distinguish realistic prospective tenants 32 from those who are not 33, and therefore would not waste their time working with or posting prospective tenants with unrealistic expectations 35.

As is made clear by the diagram, broker-generated prospective tenant listings systems are preferable to the prospective tenant-generated prospective tenant listings system as all of the good prospective tenant listings 34, and none of the bad ones are posted 35.

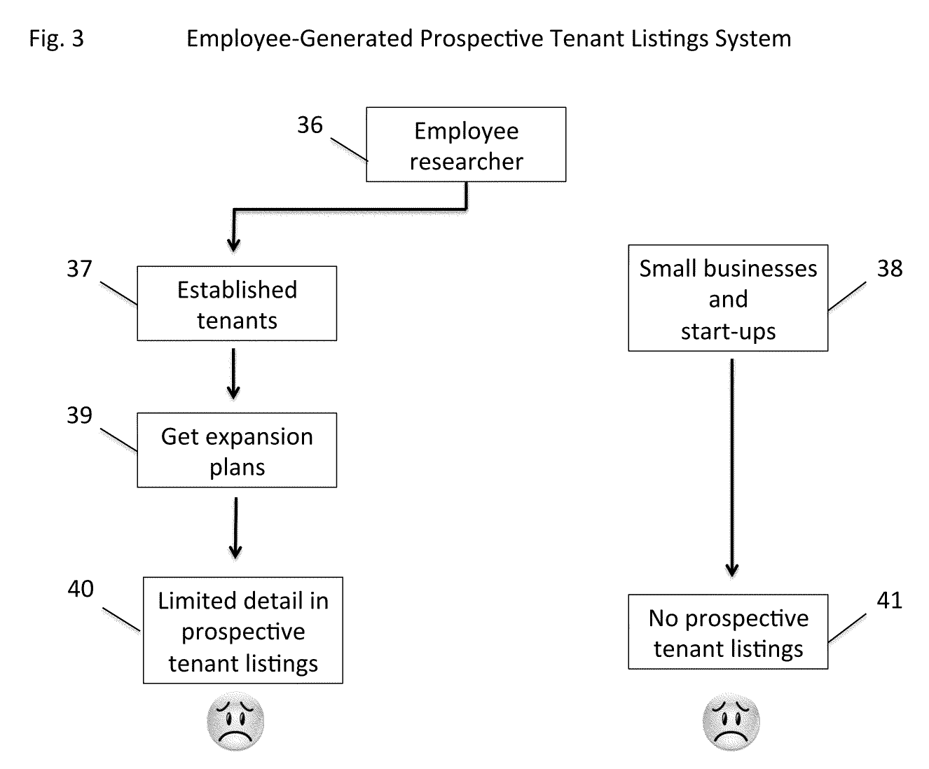

FIG. 3 is a flow chart demonstrating which segments of the prospective tenant market an employee-generated system will source for prospective tenant listings and the quality of information on these prospective tenant listings.

An employee-generated prospective tenant listings system does not have the capacity to reach the entire prospective tenant market. The employees who generate the prospective tenant listings are unable to contact small businesses or start-ups effectively 38. Although they could by chance come across these segments, generally speaking there are too many small businesses to be effectively reached by an employee system. Furthermore start-ups often don't have any offices in their early stages so there is no phone number or contact information listed for the employees to reach out to them at. For this reason, small businesses and start-ups 38 will seldom be posted on these databases 41.

While employee-generated systems do reach out to established tenants 37, the information solicited from these tenants tends to be highly limited. The tenants often tell the employee researchers 36 about their expansion plans 39. However, because these employees are not actually helping them find space, the details of these plans tend to be general and of a more overarching expansion strategy, rather than their specific plans for a store or office. This is why employee-generated prospective tenant listings systems are dominated by prospective tenant listings that are limited in detail and come almost exclusively from established businesses 40.

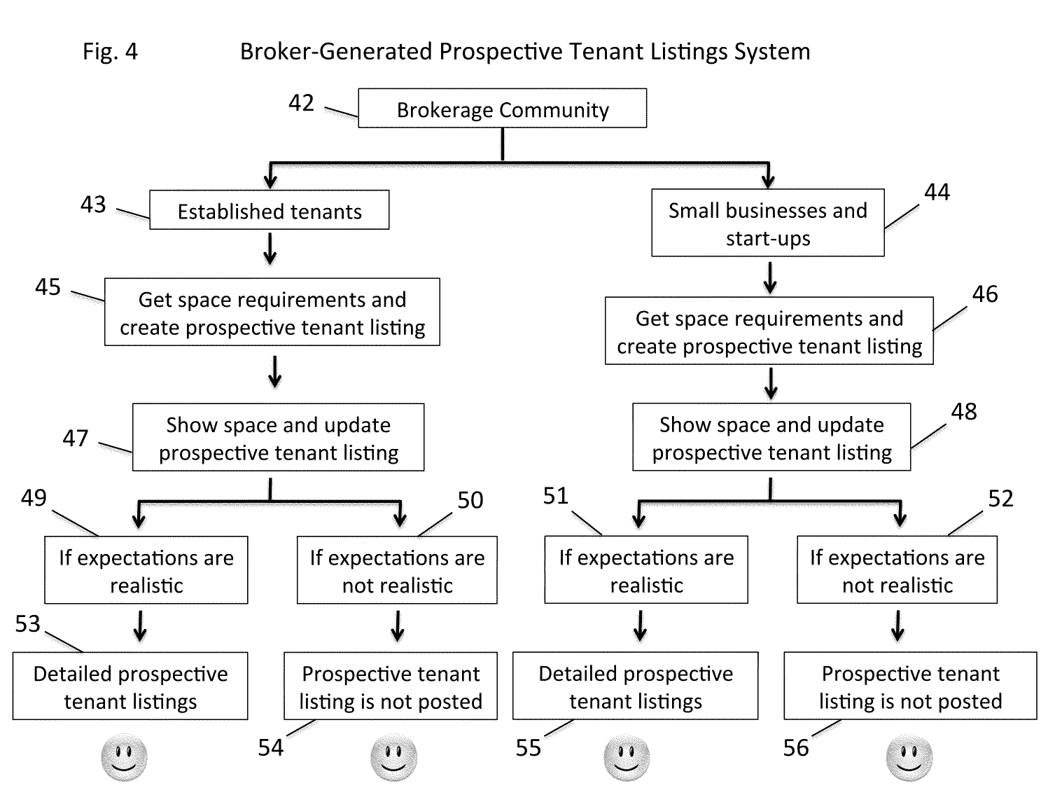

FIG. 4 is a flow chart demonstrating which segments of the prospective tenant market a broker-generated system will source for prospective tenant listings and the quality of information on these prospective tenant listings.

A broker-generated prospective tenant listings system is advantageous for many reasons, but two characteristics in particular stand out.

First, brokers are everywhere. They represent all possible prospective tenants from the largest firms to the smallest start-ups. They specialize in all different types of prospective tenants from tech companies to florists. Additionally, they have incredibly diverse methods on how to attain new clients and therefore find their way into every corner of the market. When somebody is looking for space but is unknown as is the case with start-ups, they will often reach out to a broker to help them find space. This characteristic allows brokers to be pervasive throughout the prospective tenant pool, having access to established tenants 44 as well as small businesses and start-ups 45.

A second characteristic which gives a broker-generated system an edge is that brokers are actually in the business of helping people find space. So while the research employee may find out that an established tenant wants to open five stores next year, the broker will need to find out specific criteria about sites they are looking for 45. During the course of their representation, prospective tenant's needs are ever-evolving 47. Brokers are well positioned to re-evaluate their prospective tenant's goals, and decide whether they are still realistic 49/50. When they are realistic, brokers will be able to post the updated information to ensure an accurate and detailed prospective tenant listing 53. If a broker discovers that their prospective tenant's expectations are unrealistic the broker will not post the prospective tenant at all 54. All outcomes of a broker-generated prospective tenant listings system are beneficial to the database.

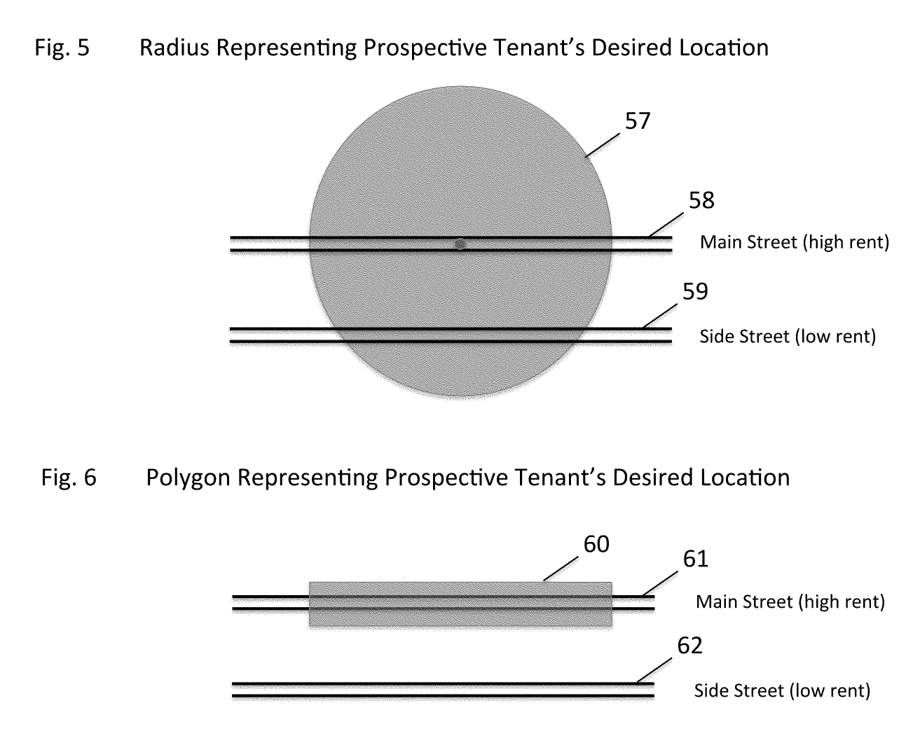

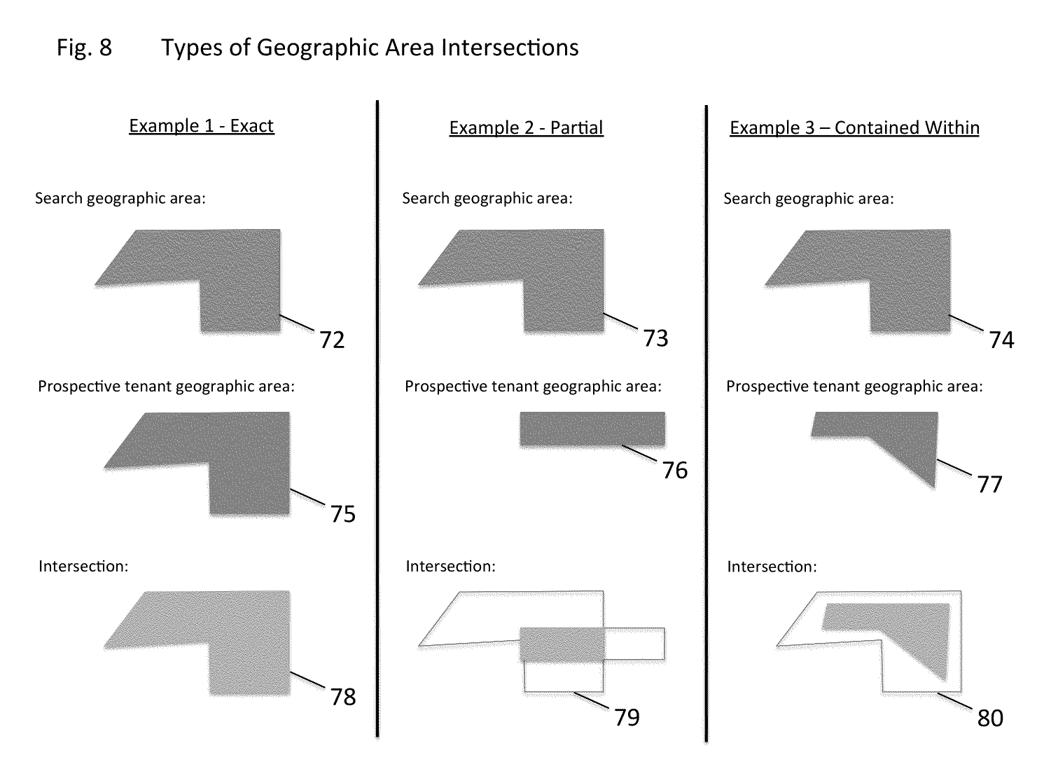

FIG. 5 demonstrates why using a radius to represent a prospective tenant's prospective tenant geographic area 57 (defined in the detailed description of FIG. 8) is not optimal. In this example a prospective tenant is seeking a space on a high rent block, Main Street 58, which is near to a lower rent location. 59. When representing their search needs via a radius tool, it looks as if the prospective tenant wants to be located on Side Street 59 as well. This is far from efficient as anyone representing a property on Side Street 59 that sees this prospective tenant's search area will send information about the property on Side Street, wasting time for both parties.

FIG. 6 demonstrates why using a polygon 60 to represent a prospective tenant's prospective tenant geographic area is advantageous. Using a polygon, the prospective tenant from the example outlined in FIG. 5 can demonstrate his search needs as only on the street of interest, Main Street 61, and therefore will not receive information from Side Street 62 landlords or their representatives.

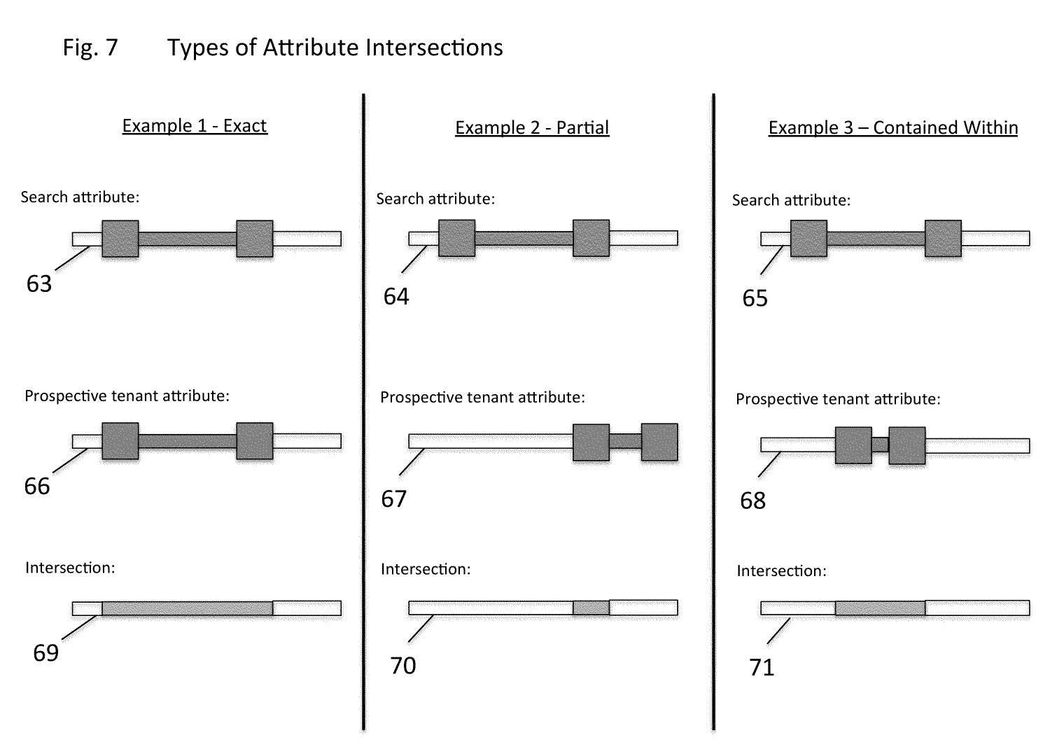

FIG. 7 is a diagram demonstrating types of intersections between search attributes 63-65 and prospective tenant attributes 66-68, both in the form of ranges.

A search attribute is any non-geographic information (e.g. size, rent, term, etc.) inputted when searching for prospective tenants. A search attribute can be in the form of a range, which is defined as the limit or limits between which variation is possible for a search attribute, as inputted by a user. A search attribute can also not be in the form of a range (e.g. a single value).

A prospective tenant attribute is any non-geographic information (e.g. size, rent, term, etc.) inputted when creating a prospective tenant listing. Broker information (e.g. broker's name, company, phone number, email address, etc.) is not a prospective tenant attribute as the broker information is information about the broker's account, not the prospective tenant's needs. A prospective tenant attribute can be in the form of a range, which is defined as the limit or limits between which variation is possible for a prospective tenant attribute, as inputted by a user. A prospective tenant attribute can also not be in the form of a range (e.g. a single value).

An attribute intersection 69-71 occurs when a search attribute 63-65 has one or more values in common with a prospective tenant attribute 69-71 of the same type (e.g. rent compared to rent, size compared to size, term compared to term, etc.). Sometimes a search attribute or prospective tenant attribute will be in the form of a range and the other attribute will not be in the form of a range. In this case, the intersection definition still applies (i.e. an attribute in the form of a range can be compared to an attribute that is not in the form of a range given that the attributes are of the same type).

An attribute intersection can fall within any of the following three categories:

Example 1 is an exact intersection 69. An exact intersection occurs when the search attribute 63 is identical to the prospective tenant attribute 66. An example of this would be if a user is searching for prospective tenant listings with size needs of 500 to 700 square feet and there is a prospective tenant listing that has a size requirement of exactly 500 to 700 square feet. Another example would be if a user is searching for prospective tenant listings with a rent range of $8,000 to $10,000 per month and there is a prospective tenant listing that has a rent range of $8,000 to $10,000 per month. Another example would be if a user is searching for prospective tenant listings that require cooking and there is a prospective tenant listing that needs to cook.

Example 2 is a partial intersection 70. A partial intersection occurs when the search attribute 64 and prospective tenant attribute 67 are different from each other but contain some of the same data points. An example of this would be if a user is searching for prospective tenant listings with term needs of 7 to 10 years and there is a prospective tenant listing that has a term requirement of 5 to 8 years. Another example would be if a user is searching for prospective tenant listings with a size range of 1,000 to 1,500 square feet and there is a prospective tenant listing that has a size requirement of 1,250 to 1,750 square feet.

Example 3 is a contained within intersection 71. A contained within intersection occurs when all data points of either the search attribute or the prospective tenant attribute are entirely contained within the attribute of the other. In FIG. 7, the prospective tenant attribute 68 is contained within the search attribute 65. An example of this would be if a user is searching for prospective tenant listings with size needs of 5,000 to 10,000 square feet and there is a prospective tenant listing that has a size requirement of 7,000 to 8,000 square feet. Another example would be if a user is searching for prospective tenant listings with size needs of 1,500 to 2,000 square feet and there is a prospective tenant listing that has a size requirement of 1,000 to 3,000 square feet.

FIG. 8 is a diagram demonstrating types of intersections between search geographic areas 72-74 and prospective tenant geographic areas 75-77.

A search geographic area 72-74 is geographic information inputted when searching for prospective tenants.

A prospective tenant geographic area 75-77 is geographic information inputted when creating a prospective tenant listing.

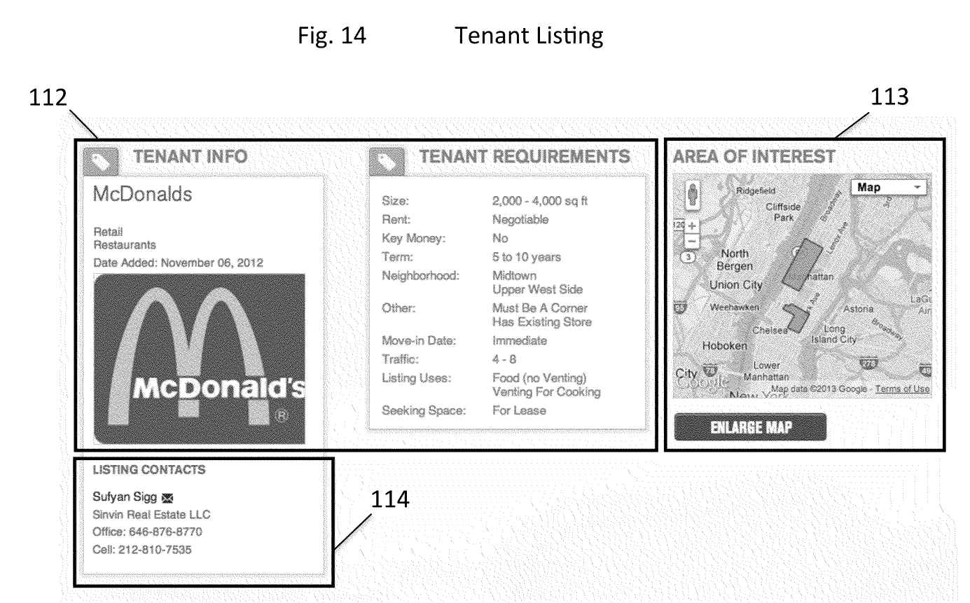

Examples of geographic information include but are not limited to two-dimensional shapes, neighborhoods, cities, states, municipalities, a specific address, or any verbal description of an area. Any locational information within the broker information (defined in detailed description of FIG. 14) is not a prospective tenant geographic area.

A geographic area intersection 78-80 occurs when search geographic area 72-74 has one or more points in common with prospective tenant geographic area 75-77.

A geographic area intersection can fall within any of the following three categories:

Example 1 is an exact intersection 78. An exact intersection occurs when the search geographic area 72 is identical to the prospective tenant geographic area 75. An example of an exact intersection would be when a user selects a neighborhood as his search geographic area and there is a prospective tenant listing whose prospective tenant geographic area is the exact same neighborhood.

Example 2 is a partial intersection 79. A partial intersection occurs when the search geographic area 73 and prospective tenant geographic area 76 are different from each other but contain at least one of the same data points. An example of a partial intersection would be when a user selects a neighborhood as his search geographic area and there is a prospective tenant listing whose prospective tenant geographic area comprises part of that neighborhood as well as an adjacent neighborhood.

Example 3 is a contained within intersection 80. A contained within intersection occurs when the search geographic area and the prospective tenant geographic area are not identical, however all of the data points of either the search geographic area or the prospective tenant geographic area are entirely contained within the geographic area of the other. In FIG. 8, the prospective tenant geographic area 77 is contained within the search geographic area 74. An example of a contained within intersection would be when a user selects a neighborhood as his search geographic area and there is a prospective tenant listing whose prospective tenant geographic area comprises a larger region that entirely encapsulates the neighborhood. Another example of a contained within intersection would be when a user selects a neighborhood as his search geographic area and there is a prospective tenant listing whose prospective tenant geographic area is a smaller region that is entirely encapsulated by the neighborhood. Another example of a contained within intersection would be when a user selects a specific address as his search geographic area and there is a prospective tenant listing whose prospective tenant geographic area is a region which includes that address.

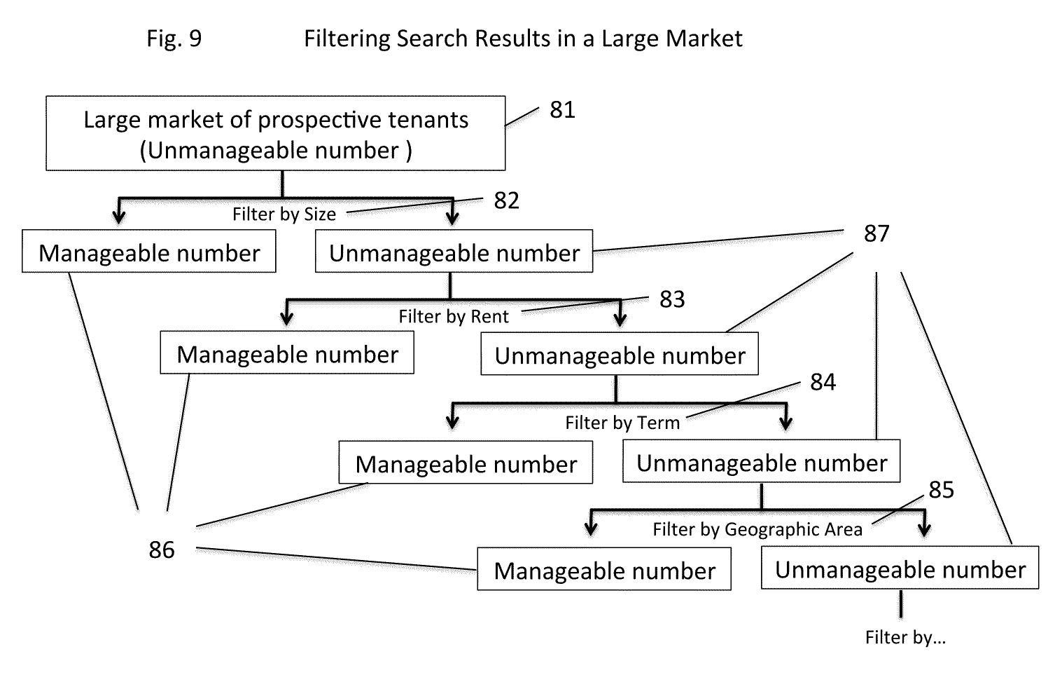

FIG. 9 is a flow chart that demonstrates how in a large market with many prospective tenants 81 using multiple search attributes and search geographic areas 82-85 can help a broker cut the prospective tenant pool into a manageable number 86.

When starting with an unmanageable number of prospective tenants 81, a broker may filter by size 82, only to find that too many options remain 87. An attempt to filter down to a manageable number using only one search attribute may result in unduly restrictive searches to the point of irrationality. For example, the only way to obtain a reasonable number of prospective tenants based on size as the sole search attribute may be by accepting people interested in 1,200 sf and rejecting people that need 1,201 and 1,199 sf. By providing multiple attributes to customize the search results a broker may be able to use the rent filter 83 along with the size filter 82, without being too restrictive with either. If this still results in too large a prospective tenant pool, further tools such as filtering by term 84 and by geographic area 85 can be used to cut the results down to a manageable number 86 without being too restrictive in any of the individual search attributes.

### Operation

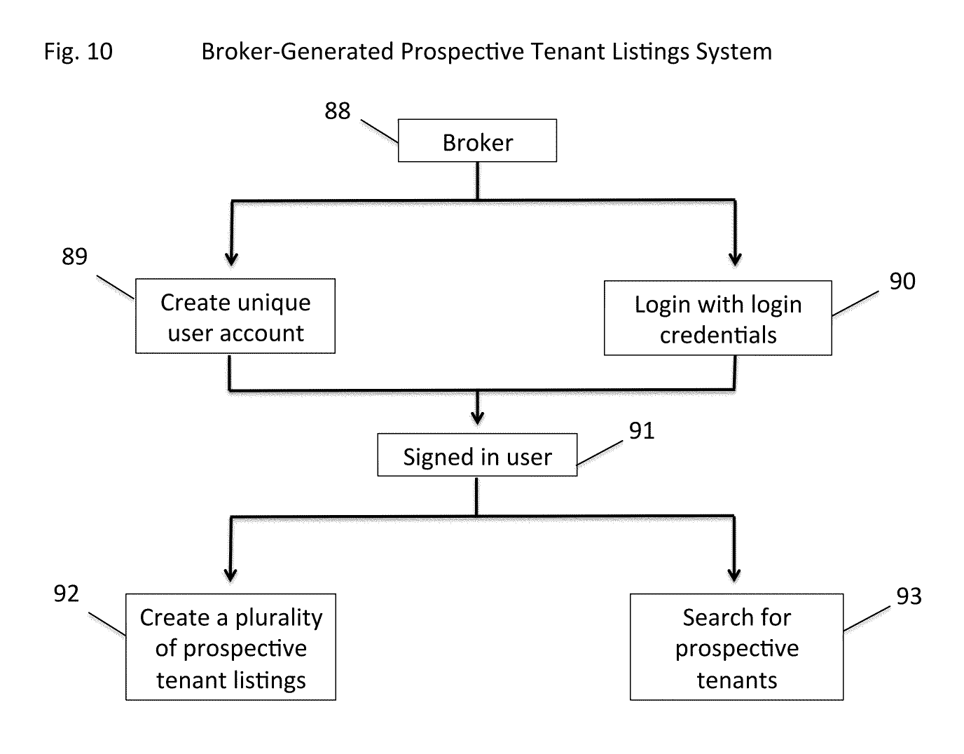

FIG. 10 is a flow chart showing the steps a broker takes to use a possible embodiment of the invention.

A first example of how this can work is if the broker 88 is already registered with an account to the web application. In this instance, he can input his unique login credentials 90 and is logged in by the web application. The logged in broker 91 then provides prospective tenant attributes and prospective tenant geographic area for the web application to create a prospective tenant listing 92. The prospective tenant listing is stored in a database. A database is defined as a collection of data that can be accessed and manipulated by a data-processing system. This process of inputting prospective tenant attributes and prospective tenant geographic area for the web application to create a prospective tenant listing is repeated by the broker to create a plurality of prospective tenant listings associated with the broker's account. This plurality of prospective tenant listings associated with the broker's account is displayed on the broker's broker profile page. Making prospective tenant listings associated with a broker's account accessible on that broker's broker profile page is advantageous.

A prospective tenant listing being associated with a broker's account is when a prospective tenant listing can be identified from information defined in the broker's account. It is also when a broker can be identified from information defined in the prospective tenant listing. The ability to have a plurality of prospective tenant listings being associated with a single broker's account is advantageous. One possible example of why a plurality of prospective tenant listings being associated with an account is advantageous is that it can allow a broker to only input their contact information one time and have it automatically put onto all of the prospective tenant listings associated with their account. Another possible advantage is that it allows a broker's prospective tenant listings to be displayed in one place such as on a broker profile page. Another possible advantage is that it allows a broker to see all of their own prospective tenant listings in one place to be easily edited and/or deleted. There are many other possible advantages as well.

Another example of how a possible embodiment of the invention can be used is that a broker goes to the web application and requests the creation of a broker account through an online form 89. Upon receipt of the request, the unique account with login credentials is created by the web application. The logged in broker 91 then provides prospective tenant attributes and prospective tenant geographic area for the web application to create a prospective tenant listing 92. The prospective tenant listing is stored in a database. A database is defined as a collection of data that can be accessed and manipulated by a data-processing system. This process of inputting prospective tenant attributes and prospective tenant geographic area for the web application to create a prospective tenant listing is repeated by the broker to create a plurality of prospective tenant listings on the broker's account. This plurality of prospective tenant listings associated with the broker's account is displayed on the broker's broker profile page.

Another example of how a possible embodiment of the invention can be used is that a broker calls a web application representative and requests a unique account. Upon receipt of the request the web application representative relays the request to the web application at which time the unique account with login credentials is created by the web application. The broker inputs his login credentials 90 and is logged in by the web application. The logged in broker 91 then provides prospective tenant attributes and prospective tenant geographic area for the web application to create a prospective tenant listing 92. The prospective tenant listing is stored in a database. A database is defined as a collection of data that can be accessed and manipulated by a data-processing system. This process of inputting prospective tenant attributes and prospective tenant geographic area for the web application to create a prospective tenant listing is repeated by the broker to create a plurality of prospective tenant listings on the broker's account. This plurality of prospective tenant listings associated with the broker's account is displayed on the broker's broker profile page.

Another example of how a possible embodiment of the invention can be used is that a broker emails a web application representative to request a unique account. Upon receipt of the request the web application representative relays the request to the web application at which time the unique account with login credentials is created by the web application. The broker inputs his login credentials 90 and is logged in by the web application. The logged in broker 91 then provides prospective tenant attributes and prospective tenant geographic area for the web application to create a prospective tenant listing 92. The prospective tenant listing is stored in a database. A database is defined as a collection of data that can be accessed and manipulated by a data-processing system. This process of inputting prospective tenant attributes and prospective tenant geographic area for the web application to create a prospective tenant listing is repeated by the broker to create a plurality of prospective tenant listings on the broker's account. This plurality of prospective tenant listings associated with the broker's account is displayed on the broker's broker profile page.

Another example of how a possible embodiment of the invention can be used is that a web application representative has the web application create a unique account for a broker and informs the broker of the creation of the account and his login credentials. The broker inputs his login credentials 90 and is logged in by the web application. The logged in broker 91 then provides prospective tenant attributes and prospective tenant geographic area for the web application to create a prospective tenant listing 92. The prospective tenant listing is stored in a database. A database is defined as a collection of data that can be accessed and manipulated by a data-processing system. This process of inputting prospective tenant attributes and prospective tenant geographic area for the web application to create a prospective tenant listing is repeated by the broker to create a plurality of prospective tenant listings on the broker's account. This plurality of prospective tenant listings associated with the broker's account is displayed on the broker's broker profile page.

Another example of how a possible embodiment of the invention can be used is that a web application representative calls a broker and asks the broker if he would like to create an account. If the broker responds affirmatively, the web application representative has the web application create a unique account 89 for the broker and informs him of the creation of the account and his login credentials. The broker inputs his login credentials 90 and is logged in by the web application. The logged in broker 91 then provides prospective tenant attributes and prospective tenant geographic area for the web application to create a prospective tenant listing 92. The prospective tenant listing is stored in a database. A database is defined as a collection of data that can be accessed and manipulated by a data-processing system. This process of inputting prospective tenant attributes and prospective tenant geographic area for the web application to create a prospective tenant listing is repeated by the broker to create a plurality of prospective tenant listings on the broker's account. This plurality of prospective tenant listings associated with the broker's account is displayed on the broker's broker profile page.

Another example of how a possible embodiment of the invention can be used is that a web application representative emails a broker and asks the broker if he would like to create an account. If the broker responds affirmatively, the web application representative has the web application create a unique account for the broker and informs him of the creation of the account and his login credentials. The broker inputs his login credentials 90 and is logged in by the web application. The logged in broker 91 then provides prospective tenant attributes and prospective tenant geographic area for the web application to create a prospective tenant listing 92. The prospective tenant listing is stored in a database. A database is defined as a collection of data that can be accessed and manipulated by a data-processing system. This process of inputting prospective tenant attributes and prospective tenant geographic area for the web application to create a prospective tenant listing is repeated by the broker to create a plurality of prospective tenant listings on the broker's account. This plurality of prospective tenant listings associated with the broker's account is displayed on the broker's broker profile page.

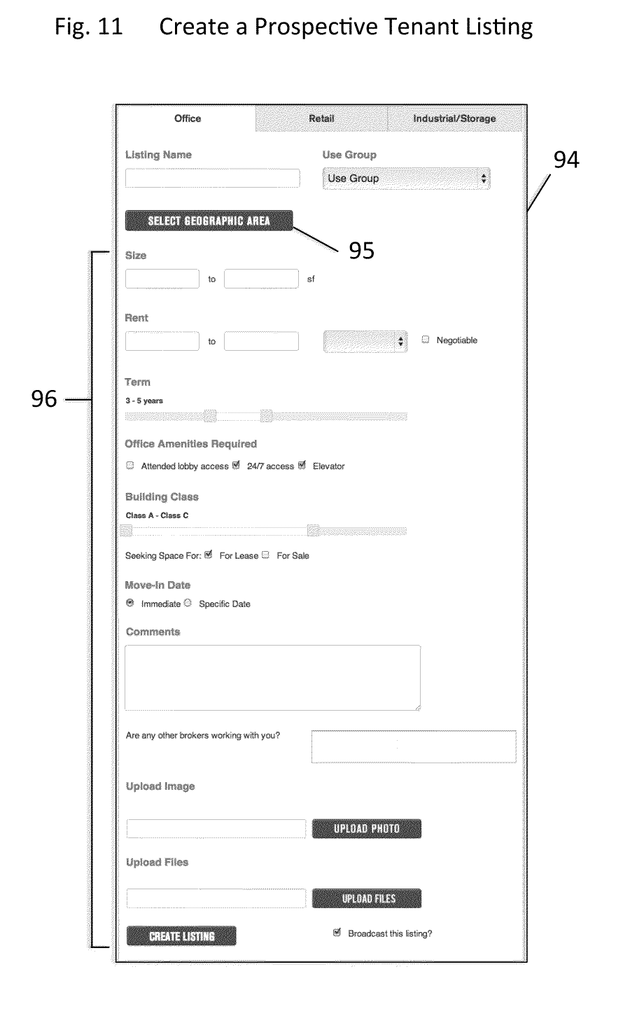

FIG. 11 is a possible embodiment of the invention showing how a prospective tenant's prospective tenant attributes 96 and prospective tenant geographic area 95 can be received by the web application in order to create a prospective tenant listing. The prospective tenant attributes, the prospective tenant geographic area, and the broker information are the three parts comprising a prospective tenant listing.

In this example, a broker goes to the web application and completes an online form, inputting prospective tenant attributes and prospective tenant geographic area. The prospective tenant listing is created by the web application and stored in a database. A database is defined as a collection of data that can be accessed and manipulated by a data-processing system. This process of inputting prospective tenant attributes and prospective tenant geographic area for the web application to create a prospective tenant listing is repeated by the broker to create a plurality of prospective tenant listings on the broker's unique account. This plurality of prospective tenant listings associated with the broker's account is displayed on the broker's broker profile page.

In another example, a broker calls a web application representative and provides prospective tenant attributes and prospective tenant geographic area. The web application representative completes an online form, inputting the prospective tenant attributes and prospective tenant geographic area. The prospective tenant listing is created by the web application and stored in a database. A database is defined as a collection of data that can be accessed and manipulated by a data-processing system. This process of inputting prospective tenant attributes and prospective tenant geographic area for the web application to create a prospective tenant listing is repeated by the broker to create a plurality of prospective tenant listings on the broker's unique account. This plurality of prospective tenant listings associated with the broker's account is displayed on the broker's broker profile page.

In another example, a broker emails a web application representative and provides prospective tenant attributes and prospective tenant geographic area. The web application representative completes an online form, inputting the prospective tenant attributes and prospective tenant geographic area. The prospective tenant listing is created by the web application and stored in a database. A database is defined as a collection of data that can be accessed and manipulated by a data-processing system. This process of inputting prospective tenant attributes and prospective tenant geographic area for the web application to create a prospective tenant listing is repeated by the broker to create a plurality of prospective tenant listings on the broker's unique account. This plurality of prospective tenant listings associated with the broker's account is displayed on the broker's broker profile page.

In another example, a web application representative completes an online form, inputting the prospective tenant attributes and prospective tenant geographic area of a prospective tenant who is known to be working with a specific broker. The prospective tenant listing is created by the web application on the specific broker's unique account to be stored in a database. A database is defined as a collection of data that can be accessed and manipulated by a data-processing system. The web application representative informs the broker for whom the prospective tenant listing was created of the creation of said prospective tenant listing. This process of inputting prospective tenant attributes and prospective tenant geographic area for the web application to create a prospective tenant listing is repeated by the web application representative to create a plurality of prospective tenant listings for the specific broker's account. This plurality of prospective tenant listings associated with the broker's account is displayed on the broker's broker profile page.

Another example is that a web application representative calls a broker and asks the broker if he would like to provide prospective tenant attributes and prospective tenant geographic area. If the broker responds affirmatively and provides prospective tenant attributes and prospective tenant geographic area, the web application representative completes an online form inputting the prospective tenant attributes and prospective tenant geographic area. The prospective tenant listing is created by the web application in the broker's account to be stored in a database. A database is defined as a collection of data that can be accessed and manipulated by a data-processing system. This process of inputting prospective tenant attributes and prospective tenant geographic area for the web application to create a prospective tenant listing is repeated by the web application representative to create a plurality of prospective tenant listings on the broker's account. This plurality of prospective tenant listings associated with the broker's account is displayed on the broker's broker profile page.

Another example is that a web application representative emails a broker and asks the broker if he would like to provide prospective tenant attributes and prospective tenant geographic area. If the broker responds affirmatively and provides prospective tenant attributes and prospective tenant geographic area, the web application representative completes an online form inputting the prospective tenant attributes and prospective tenant geographic area. The prospective tenant listing is created by the web application in the broker's account to be stored in a database. A database is defined as a collection of data that can be accessed and manipulated by a data-processing system. This process of inputting prospective tenant attributes and prospective tenant geographic area for the web application to create a prospective tenant listing is repeated by the web application representative to create a plurality of prospective tenant listings on the broker's account. This plurality of prospective tenant listings associated with the broker's account is displayed on the broker's broker profile page.

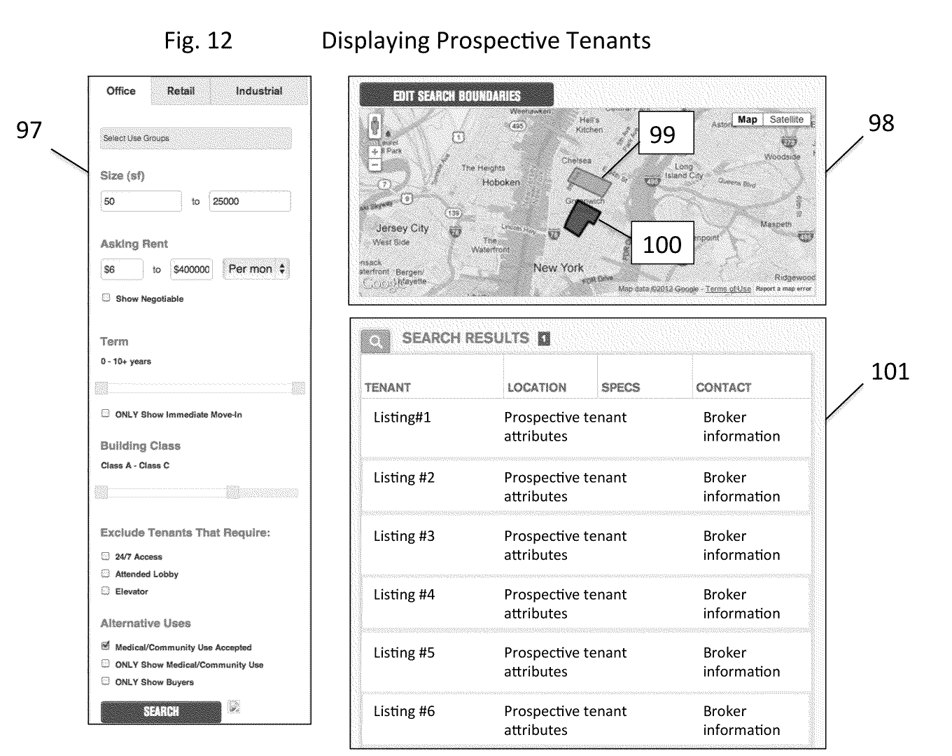

FIG. 12 is a possible embodiment of the invention showing how search attributes 97 and search geographic area 98 can be received by the web application, which then displays the appropriate prospective tenant listings. In this example a user inputs search attributes via an online form to specify what kind of prospective tenants they are looking for. In addition to the search attributes, the results are further filtered through the user inputting search geographic areas with the locations or areas where the user wants the prospective tenants to be looking for space. The green search geographic area is a polygonal search geographic area created by the user 99 while the red one is a predetermined search geographic area selected by the user 100. The search results 101 will consist of the prospective tenant listings that intersect with the search attributes and the search geographic area. These prospective tenant listings can but do not need to be displayed in full (i.e. all the prospective tenant attributes and all the prospective tenant geographic area). A prospective tenant listing is deemed to be displayed so long as any portion of either the prospective tenant attributes or the prospective tenant geographic area is displayed. Just displaying broker information is not deemed as displaying a prospective tenant listing. (Examples here) Displaying, at a minimum, any portion of either the prospective tenant attributes or the prospective tenant geographic area is advantageous.

In this example, a user goes to the web application and completes an online form, inputting search attributes and search geographic area. The web application then searches the database for prospective tenant listings that intersect with the search attributes and the search geographic area. The web application then displays the prospective tenant listings that intersect with the search attributes and the search geographic area.

Another possible example of a prospective tenant listing being displayed is when only broker information is displayed and then through a single link, or a series of links, any portion of the prospective tenant attributes or prospective tenant geographic area of that listing are displayed.

Another possible example of a prospective tenant listing being displayed is when only broker information is displayed and then through a single link, or a series of links a user is brought to that broker's broker profile page where any portion of the prospective tenant attributes or prospective tenant geographic area is displayed.

A possible example of a prospective tenant listing not being displayed is when only broker information such as broker name, broker company, broker company location or area of specialty, and broker phone number is made available and there is no way to access the tenant attributes or tenant geographic area of a prospective tenant listing.

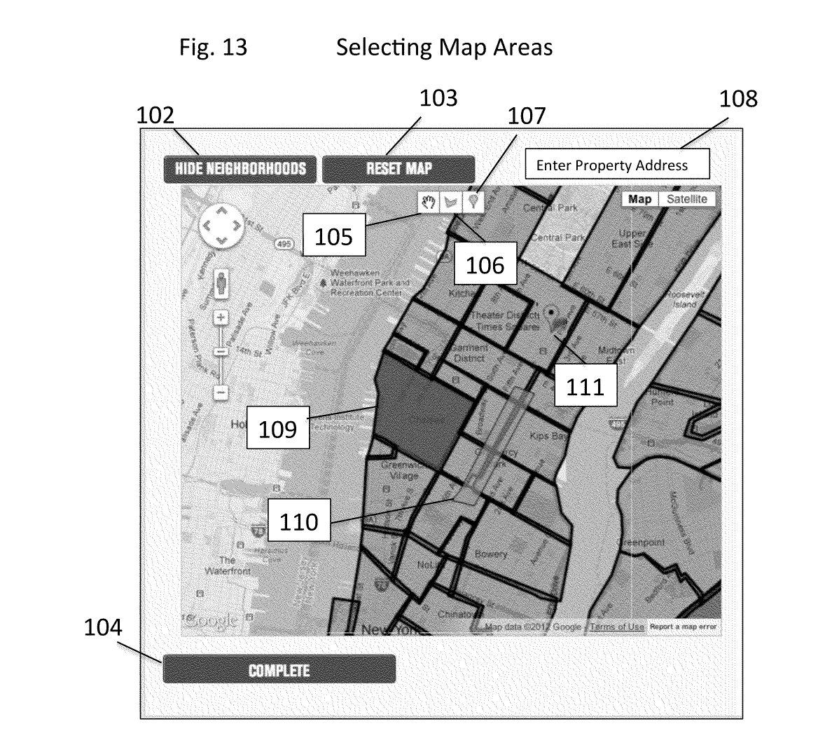

FIG. 13 is a possible embodiment of the invention showing how the web application can receive search geographic area or prospective tenant geographic area.

In this example, when using the map to select either a search geographic area or a prospective tenant geographic area, the user has three types of selection options. First, the user can select a predetermined geographic area depicting a neighborhood using the hand tool 105. The user may also specify geographic areas by using the polygon tool 106 and drawing a polygon directly onto the map. Lastly, a user can specify one particular location instead of a larger area using the drop-a-pin tool 107. Drop-a-pin selections work by selecting the drop-a-pin button 107 and choosing where to place the pin on the map 111. Additionally, a user can drop-a-pin by typing in a specific address 108 and hitting the enter key. Because a pin indicates a one-dimensional area, it will only ever be part of an exact match 78 or more likely, a contained within match 80.

Two additional tools are in place to facilitate the geographic selection process. First the user can move the map by clicking and dragging with the hand tool 105. The user also has the option to hide the predetermined geographic areas depicting neighborhoods by selecting the “hide neighborhoods” button 102.

All these tools can be used together to customize the geographic area selection. Selected predetermined geographic areas depicting neighborhoods show up in red 109, while selected polygons are displayed in green 110. To reset all neighborhood, polygon, or drop a pin searches the user can select the reset map button 103. To finalize all the selections, the user will click the complete button 104.

FIG. 14 is a possible embodiment of the invention showing how the web application can display a tenant listing.

In this example, the prospective tenant attributes 112 include the listing title, use group, date added, and various other space requirements. In some instances, instead of the listing title being the actual name of the prospective tenant, a broker may choose a title that does not disclose a prospective tenant's identity such as “Well-Financed Tech Start-Up” or even a title that has seemingly the prospective tenant such as “Prospective Tenant 1” or “Sjdkfjls.” The prospective tenant geographic area 113 is displayed as a map with the areas with which the prospective tenant is seeking space are highlighted in green. In some instances, instead of the prospective tenant geographic area being in the form of a map, it could be just a verbal description such as a city, state, country, municipality etc. The broker information 114 includes but is not limited to the broker's name, company, and various other contact information.

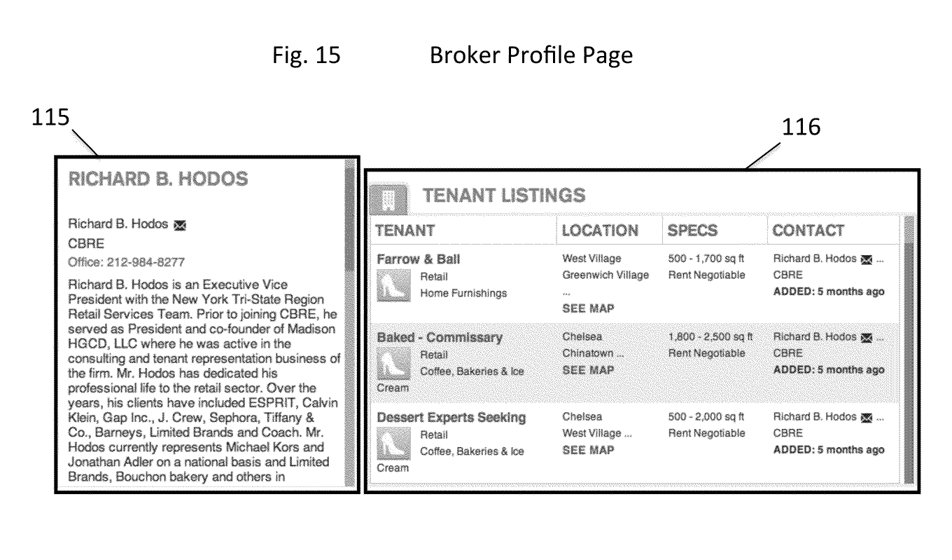

FIG. 15 is a possible embodiment of the invention showing how the web application can display a broker profile page.

In this example, the broker information 115 includes the broker's name, company, contact info and bio. All the prospective tenant listings 116 associated with this broker's account are displayed. This is just one example of a broker profile page. A broker profile page is deemed to be a broker profile page so long as a plurality of prospective tenant listings associated with a particular broker's account are displayed. Making prospective tenant listings associated with a broker's account accessible on that broker's broker profile page is advantageous.

Here is another embodiment of the invention: The web application creates a first prospective tenant listing using a first set of prospective tenant attributes and a first prospective tenant geographic area. This first prospective tenant listing is associated with a user's account. After the first prospective tenant listing is created, the web application creates a second prospective tenant listing using a second set of prospective tenant attributes and a second prospective tenant geographic area. This second prospective tenant listing is associated with the user's account. A user provides a set of search attributes and a search geographic area. The web application determines if these search attributes and search geographic area intersect with the prospective tenant attributes and the prospective tenant geographic area of the first prospective tenant listing or any other prospective tenant listings on the site. The web application then displays any prospective tenant listings that intersect with the search attributes and search geographic area.

Here is another embodiment of the invention: The web application provides a first online form to receive requests for an account to be created. When a request is received from a broker via the first online form, the web application creates a unique account with login credentials for the broker. When the web application receives login credentials from the broker, the web application logs the broker into the broker's account. The web application provides a second online form to receive prospective tenant attributes and prospective tenant geographic area. When the web application receives a first set of prospective tenant attributes and a first prospective tenant geographic area from the broker via the second online form, the web application creates a first prospective tenant listing which is associated with the broker's account. This first prospective tenant listing includes the first set of prospective tenant attributes and the first prospective tenant geographic area. This first prospective tenant listing is stored in a database and is made accessible on the broker's broker profile page. Then the web application receives a second set of prospective tenant attributes and a second prospective tenant geographic area from the broker via the second online form. When this occurs, the web application creates a second prospective tenant listing which is associated with the broker's account. This second prospective tenant listing includes the second set of prospective tenant attributes and the second prospective tenant geographic area. This second prospective tenant listing is stored in a database and is made accessible on the broker's broker profile page alongside the first prospective tenant listing. The web application provides a third online form to receive search attributes and search geographic area. When the web application receives a set of search attributes and a search geographic area, the web application displays the first prospective tenant listing if the first set of prospective tenant attributes and the first prospective tenant geographic area intersect with the set of search attributes and the search geographic area.

Here is another embodiment of the invention: The web application provides a first online form to receive requests for an account to be created. When a request is received from a web application representative via the first online form, the web application creates a unique account with login credentials. The web application representative informs a broker that an account has been created and provides the broker with the login credentials to sign into the account. When the web application receives login credentials from the broker, the web application logs the broker into the broker's account. The web application provides a second online form to receive prospective tenant attributes and prospective tenant geographic area. When the web application receives a first set of prospective tenant attributes and a first prospective tenant geographic area from the broker via the second online form, the web application creates a first prospective tenant listing which is associated with the broker's account. This first prospective tenant listing includes the first set of prospective tenant attributes and the first prospective tenant geographic area. This first prospective tenant listing is stored in a database and is made accessible on the broker's broker profile page. Then the web application receives a second set of prospective tenant attributes and a second prospective tenant geographic area from the broker via the second online form. When this occurs, the web application creates a second prospective tenant listing which is associated with the broker's account. This second prospective tenant listing includes the second set of prospective tenant attributes and the second prospective tenant geographic area. This second prospective tenant listing is stored in a database and is made accessible on the broker's broker profile page alongside the first prospective tenant listing. The web application provides a third online form to receive search attributes and search geographic area. When the web application receives a set of search attributes and a search geographic area, the web application displays the first prospective tenant listing if the first set of prospective tenant attributes and the first prospective tenant geographic area intersect with the set of search attributes and the search geographic area.

Here is another embodiment of the invention: The web application provides a first online form to receive requests for an account to be created. When a request is received from a broker via the first online form, the web application creates a unique account with login credentials for the broker. When the web application receives login credentials from the broker, the web application logs the broker into the broker's account. The web application provides a second online form to receive prospective tenant attributes and prospective tenant geographic area. When the web application receives a first set of prospective tenant attributes and a first prospective tenant geographic area from the broker via the second online form, the web application creates a first prospective tenant listing which is associated with the broker's account. This first prospective tenant listing includes the first set of prospective tenant attributes and the first prospective tenant geographic area. This first prospective tenant listing is stored in a database. Then the web application receives a second set of prospective tenant attributes and a second prospective tenant geographic area from the broker via the second online form. When this occurs, the web application creates a second prospective tenant listing which is associated with the broker's account. This second prospective tenant listing includes the second set of prospective tenant attributes and the second prospective tenant geographic area. This second prospective tenant listing is stored in a database alongside the first prospective tenant listing. The web application provides a third online form to receive search attributes and search geographic area. When the web application receives a set of search attributes and a search geographic area, the web application displays the first prospective tenant listing if the first set of prospective tenant attributes and the first prospective tenant geographic area intersect with the set of search attributes and the search geographic area.

Here is another embodiment of the invention: The web application provides a first online form to receive requests for an account to be created. When a request is received from a web application representative via the first online form, the web application creates a unique account with login credentials. The web application representative informs a broker that an account has been created and provides the broker with the login credentials to sign into the account. When the web application receives login credentials from the broker, the web application logs the broker into the broker's account. The web application provides a second online form to receive prospective tenant attributes and prospective tenant geographic area. When the web application receives a first set of prospective tenant attributes and a first prospective tenant geographic area from the broker via the second online form, the web application creates a first prospective tenant listing which is associated with the broker's account. This first prospective tenant listing includes the first set of prospective tenant attributes and the first prospective tenant geographic area. This first prospective tenant listing is stored in a database. Then the web application receives a second set of prospective tenant attributes and a second prospective tenant geographic area from the broker via the second online form. When this occurs, the web application creates a second prospective tenant listing which is associated with the broker's account. This second prospective tenant listing includes the second set of prospective tenant attributes and the second prospective tenant geographic area. This second prospective tenant listing is stored in a database alongside the first prospective tenant listing. The web application provides a third online form to receive search attributes and search geographic area. When the web application receives a set of search attributes and a search geographic area, the web application displays the first prospective tenant listing if the first set of prospective tenant attributes and the first prospective tenant geographic area intersect with the set of search attributes and the search geographic area.

Here is another embodiment of the invention: The web application provides a first online form to receive requests for an account to be created. When a request is received from a broker via the first online form, the web application creates a unique account with login credentials for the broker. When the web application receives login credentials from the broker, the web application logs the broker into the broker's account. The web application provides a second online form to receive prospective tenant attributes and prospective tenant geographic area. When the web application receives a first set of prospective tenant attributes and a first prospective tenant geographic area from the broker via the second online form, the web application creates a first prospective tenant listing which is associated with the broker's account. This first prospective tenant listing includes the first set of prospective tenant attributes and the first prospective tenant geographic area. This first prospective tenant listing is stored in a database and is made accessible on the broker's broker profile page. Then the web application receives a second set of prospective tenant attributes and a second prospective tenant geographic area from the broker via the second online form. When this occurs, the web application creates a second prospective tenant listing which is associated with the broker's account. This second prospective tenant listing includes the second set of prospective tenant attributes and the second prospective tenant geographic area. This second prospective tenant listing is stored in a database and is made accessible on the broker's broker profile page alongside the first prospective tenant listing.

Here is another embodiment of the invention: The web application provides a first online form to receive requests for an account to be created. When a request is received from a web application representative via the first online form, the web application creates a unique account with login credentials. The web application representative informs a broker that an account has been created and provides the broker with the login credentials to sign into the account. When the web application receives login credentials from the broker, the web application logs the broker into the broker's account. The web application provides a second online form to receive prospective tenant attributes and prospective tenant geographic area. When the web application receives a first set of prospective tenant attributes and a first prospective tenant geographic area from the broker via the second online form, the web application creates a first prospective tenant listing which is associated with the broker's account. This first prospective tenant listing includes the first set of prospective tenant attributes and the first prospective tenant geographic area. This first prospective tenant listing is stored in a database and is made accessible on the broker's broker profile page. Then the web application receives a second set of prospective tenant attributes and a second prospective tenant geographic area from the broker via the second online form. When this occurs, the web application creates a second prospective tenant listing which is associated with the broker's account. This second prospective tenant listing includes the second set of prospective tenant attributes and the second prospective tenant geographic area. This second prospective tenant listing is stored in a database and is made accessible on the broker's broker profile page alongside the first prospective tenant listing.

### CONCLUSION, RAMIFICATIONS, AND SCOPE

In conclusion, herein is presented a web application that creates a broker-generated searchable prospective tenant database while allowing users the ability to create a plurality of prospective tenant listings under a single account and making this plurality of prospective tenant listings accessible on a broker's broker profile page. The above description clearly demonstrates the numerous advantages of a broker-generated system over the alternatives. More advantages are realized through allowing multiple search and prospective tenant attributes to be used, some of which are in the form of ranges. And still more advantages are realized by illustrating tenant and search geographic areas in the form of polygons. And still more advantages are realized from allowing users to create a plurality of prospective tenant listing on a single account. And still more advantages are realized from making prospective tenant listings associated with a broker's account accessible on that broker's broker profile page. And still more advantages are realized from displaying prospective tenant listings with, at minimum, any portion of prospective tenant attributes and prospective tenant geographic area. While the above description contains many specificities, these should not be construed as limitations on the scope of the invention but rather as an exemplification of one embodiment thereof. Many other variations are possible. Accordingly, the scope of the invention should be determined not by the embodiments illustrated but by the appended claims and their legal equivalents. Such variations are contemplated as being a part of the present invention.

1. A method comprising:
a) Providing a first online form;
b) Receiving, via the first online form, a request to create an account;
c) Creating a unique account that a broker can access with a set of login credentials;
d) Receiving from the broker the login credentials;
e) Logging the broker into the account;
f) Providing a second online form;
g) Receiving, via the second online form, a first set of prospective tenant attributes and a first prospective tenant geographic area;
h) Creating a first listing, associated with the broker's account, which includes the first set of prospective tenant attributes and the first prospective tenant geographic area;
i) Storing the first listing in a database;
j) Making the first listing accessible via the broker's broker profile page;
k) After step g has been completed, receiving, via the second form, a second set of prospective tenant attributes and a second prospective tenant geographic area;
l) Creating a second listing, associated with the broker's account, which includes the second set of prospective tenant attributes and the second prospective tenant geographic area;
m) Storing the second listing in the database;
n) Making the second listing accessible via the broker's broker profile page;
o) Providing a third online form
p) Receiving, via the third online form, a set of search attributes and a search geographic area;
q) Displaying the first listing if the first set of prospective tenant attributes and the first prospective tenant geographic area intersect with the set of search attributes and the search geographic area

2. A method comprising:
a) Providing a first online form;
b) Receiving, via the first online form, a request to create an account;
c) Creating a unique account that a broker can access with a set of login credentials;
d) Receiving from the broker the login credentials;
e) Logging the broker into the account;
f) Providing a second online form;
g) Receiving, via the second online form, a first set of prospective tenant attributes and a first prospective tenant geographic area;
h) Creating a first listing, associated with the broker's account, which includes the first set of prospective tenant attributes and the first prospective tenant geographic area;
i) Storing the first listing in a database;
j) After step g has been completed, receiving, via the second form, a second set of prospective tenant attributes and a second prospective tenant geographic area;
k) Creating a second listing, associated with the broker's account, which includes the second set of prospective tenant attributes and the second prospective tenant geographic area;
l) Storing the second listing in the database;
m) Providing a third online form;
n) Receiving, via the third online form, a set of search attributes and a search geographic area;
o) Displaying the first listing if the first set of prospective tenant attributes and the first prospective tenant geographic area intersect with the set of search attributes and the search geographic area

3. A method comprising:
a) Providing a first online form;
b) Receiving, via the first online form, a request to create an account;
c) Creating a unique account that a broker can access with a set of login credentials;
d) Receiving from the broker the login credentials;
e) Logging the broker into the account;
f) Providing a second online form;
g) Receiving, via the second online form, a first set of prospective tenant attributes and a first prospective tenant geographic area;
h) Creating a first listing, associated with the broker's account, which includes the first set of prospective tenant attributes and the first prospective tenant geographic area;
i) Storing the first listing in a database;
j) Making the first listing accessible via the broker's broker profile page;
k) After step g has been completed, receiving, via the second form, a second set of prospective tenant attributes and a second prospective tenant geographic area;
l) Creating a second listing, associated with the broker's account, which includes the second set of prospective tenant attributes and the second prospective tenant geographic area;
m) Storing the second listing in the database;
n) Making the second listing accessible via the broker's broker profile page

4. The method in claim 1, wherein step g) comprises “Receiving, via the second form, from the broker a first set of prospective tenant attributes and a first prospective tenant geographic area” and step j) comprises “After step g has been completed, receiving, via the second form, from the broker a second set of prospective tenant attributes and a second prospective tenant geographic area”

5. The method in claim 2, wherein step g) comprises “Receiving, via the second form, from the broker a first set of prospective tenant attributes and a first prospective tenant geographic area” and step j) comprises “After step g has been completed, receiving, via the second form, from the broker a second set of prospective tenant attributes and a second prospective tenant geographic area”

6. The method in claim 3, wherein step g) comprises “Receiving, via the second form, from the broker a first set of prospective tenant attributes and a first prospective tenant geographic area” and step k) comprises “After step g has been completed, receiving, via the second form, from the broker a second set of prospective tenant attributes and a second prospective tenant geographic area”

7. The method in claim 1, wherein “prospective tenant” comprises “prospective commercial tenant”

8. The method in claim 2, wherein “prospective tenant” comprises “prospective commercial tenant”

9. The method in claim 3, wherein “prospective tenant” comprises “prospective commercial tenant”

10. The method in claim 4, wherein “prospective tenant” comprises “prospective commercial tenant”

11. The method in claim 5, wherein “prospective tenant” comprises “prospective commercial tenant”

12. The method in claim 6, wherein “prospective tenant” comprises “prospective commercial tenant”
